(19) United States
(12) Patent Application Publication
(10) Pub. No.: US 2011/0211821 A1
(43) Pub. Date: Sep. 1, 2011

(54) CAMERA MODULE WITH ANTI-SHAKE DEVICE

(75) Inventors: Jae Hyuk Park, Gyunggi-do (KR); Chul Yeub Han, Gyunggi-do (KR); Soo Cheol Lim, Gyunggi-do (KR)

(73) Assignee: Samsung Electro-Mechanics Co., Ltd, Gyunggi-do (KR)

(21) Appl. No.: 13/126,417

(22) PCT Filed: Dec. 10, 2009
(86) PCT No.: PCT/KR09/07386

§ 371 Date: Apr. 27, 2011

(30) Foreign Application Priority Data
Dec. 10, 2008 (KR) 10-2008-0125090

(51) Int. Cl. G03B 17/00; H04N 5/228

(52) U.S. Cl. 396/55; 348/208.11; 348/E05.031

(57) ABSTRACT

The present invention relates to a camera module equipped with a vibration compensation mechanism. The camera module includes a lens unit for changing an image of a subject at a specific magnification, a housing for accommodating the lens unit so that the lens unit can move in the direction of an optical axis, an auto-focus actuator unit installed so that the lens unit can move in the direction of the optical axis, suspension members for supporting the housing so that the housing can float in a direction perpendicular to the direction of the optical axis, a box-type case configured such that the suspension members are fastened thereto and the housing is accommodated therein, a circuit board disposed beneath the case and configured such that an image sensor is installed thereon, and a compensation actuator configured to compensate for a displacement caused by the vibration of the housing.

### TECHNICAL FIELD

The present invention relates to a camera module equipped with a vibration compensation mechanism, and, more particularly, to the implementation of a camera module equipped with a vibration compensation mechanism that can prevent the focus of a camera from being blurred by the vibration of the hands which hold the camera during its use, that is, a camera module equipped with a vibration compensation mechanism, which enables the thickness of a camera to be reduced because the vibration compensation mechanism is provided beside a lens unit and which minimizes the amount of current required to operate an auto-focus actuator unit because the weight supported by the auto-focus actuator unit is reduced.

### BACKGROUND ART

The majority of conventional vibration compensation mechanisms have been implemented in digital cameras flexible in size, rather than mobile devices such as mobile phones. However, as cameras contained in mobile devices, such as a mobile phone camera, now require high-quality images equal to those of digital cameras, research into vibration compensation mechanisms for mobile camera modules is being actively conducted by companies.

However, since vibration compensation mechanisms fitted to digital cameras are relatively large, new research needs to be carried out on vibration compensation mechanisms to be applied to cameras for mobile devices.

FIG. 4 shows a conventional camera module. The conventional camera module includes a light entrance window 10, a lower case 20, a lens tube 30, a group of lenses 31 and 32, an infrared cutoff filter 40, an image sensor 50, and a protective glass 60.

In greater detail, the conventional camera module includes the group of lenses 31 and 32 configured to include a plurality of lenses, the lens tube 30 provided with the group of lenses 31 and 32 and the light entrance window 10, the lower case 20 configured to fasten the lens tube 30, the infrared cutoff filter 40 configured to block infrared rays passing through the group of lenses 31 and 32, the image sensor 50 mounted on the lower case 20 and configured to convert a light signal passing through the group of lenses 31 and 32 into an electric signal, and the protective glass 60 configured to protect the image sensor 50.

FIG. 5 shows the process of capturing an image using the conventional camera module. In the conventional camera module, an image sensor location 53 is fixed, and therefore the distance to the subject 52 which enables an image to be formed at the image sensor location 53 is specified. The location spaced apart from the distance is an optimal focus subject surface 51. In the above-described configuration, when a subject 52 is located on the optimal focus subject surface 51, a subject image 54 is accurately formed at the image sensor location 53 and optimal capturing can be performed.

However, when there is vibration in a user's hands which hold the camera module, the subject image 54 moves to a different location 55 and therefore the focus of the camera vibrates, so that the phenomenon of blurring of the subject image occurs.

Although a stand for preventing a camera from vibrating is sometimes used to mitigate the above-described problem, the camera stand inconveniences general users because it is large-sized, is heavy, and has a complicated method of use. When a user attempts to capture an image without using the camera stand because of the above inconvenience, the focus of the camera module is blurred by the vibration of the user's hands, and therefore a reduction in the quality of a captured image occurs.

The above problems do not only meet consumers' demands for the convenient use of cameras and high image quality, but also incur expenses resulting from the disposal of low-quality photos.

### DISCLOSURE

### Technical Problem

Accordingly, the present invention has been made keeping in mind the above problems occurring in the prior art, and an object of the present invention is to implement a camera module equipped with a vibration compensation mechanism that can prevent the focus of a camera from being blurred by the vibration of the hands which hold the camera during its use, and to provide a camera module equipped with a vibration compensation mechanism, which enables the thickness of a camera to be reduced because the vibration compensation mechanism is provided beside a lens unit and which minimizes the amount of current required to operate an auto-focus actuator unit because the weight supported by the auto-focus actuator unit is reduced.

### Technical Solution

In order to accomplish the above object, the present invention provides a camera module equipped with a vibration compensation mechanism, including a lens unit including a plurality of lenses for changing an image of a subject at a specific magnification; a housing for accommodating the lens unit so that the lens unit can move in the direction of an optical axis; an auto-focus actuator unit installed in the lens unit and the housing so that the lens unit can move in the direction of the optical axis; suspension members for supporting the housing in parallel with the direction of the optical axis so that the housing can float in a direction perpendicular to the direction of the optical axis; a box-type case configured such that the suspension members are fastened thereto and the housing is accommodated therein; a circuit board disposed beneath the case and configured such that an image sensor is installed thereon; and a compensation actuator installed in the housing and the case and configured to compensate for a displacement caused by a vibration of the housing.

Furthermore, the suspension members may be four suspension wires which support the four corners of the box-type housing.

Furthermore, the camera module may further include a displacement sensor for sensing a vibration displacement of the housing.

Furthermore, the auto-focus actuator unit may be formed of a voice-coil, piezoelectric, or Shape Memory Alloy (SMA) actuator.

Furthermore, the compensation actuator may include second coils provided on the four side walls of the housing, respectively, second magnets provided on the four side walls of the case to face the second coils, respectively, and metallic yokes configured to concentrate the magnetic force of the magnets.

### Advantageous Effects

According to the present invention, a camera module equipped with a vibration compensation mechanism is provided. That is, the present invention implements a camera module equipped with a vibration compensation mechanism that can prevent the focus of a camera from being blurred by the vibration of the hands which hold the camera during its use, and the present invention provides a camera module equipped with a vibration compensation mechanism, which enables the thickness of a camera to be reduced because the vibration compensation mechanism is provided beside a lens unit and which minimizes the amount of current required to operate an auto-focus actuator unit because the weight supported by the auto-focus actuator unit is reduced.

### DESCRIPTION OF DRAWINGS

FIG. 1 is an exploded view of a camera module equipped with a vibration compensation mechanism according to the present invention;

FIG. 2 is a sectional view of the camera module equipped with a vibration compensation mechanism according to the present invention;

FIG. 3 is a detailed sectional view of the camera module equipped with a vibration compensation mechanism according to the present invention;

FIG. 4 is a detailed sectional view of a conventional camera module; and

FIG. 5 is a diagram illustrating the adjustment of a focus of the conventional camera module.

### DESCRIPTION OF REFERENCE NUMERALS OF PRINCIPAL COMPONENTS IN THE DRAWINGS

| | |
|---|---|
| 100: camera module | 110: lens unit |
| 120: housing | 130: auto-focus actuator unit |
| 140: suspension member | 150: case |
| 160: circuit board | 161: image sensor |
| 165: displacement sensor | 170: compensation actuator |
| 171: second coil | 172: second magnet |
| 173: metallic yoke | |

### MODE FOR INVENTION

A camera module 100 equipped with a vibration compensation mechanism according to an embodiment of the present invention will be described in detail below with reference to the accompanying drawings.

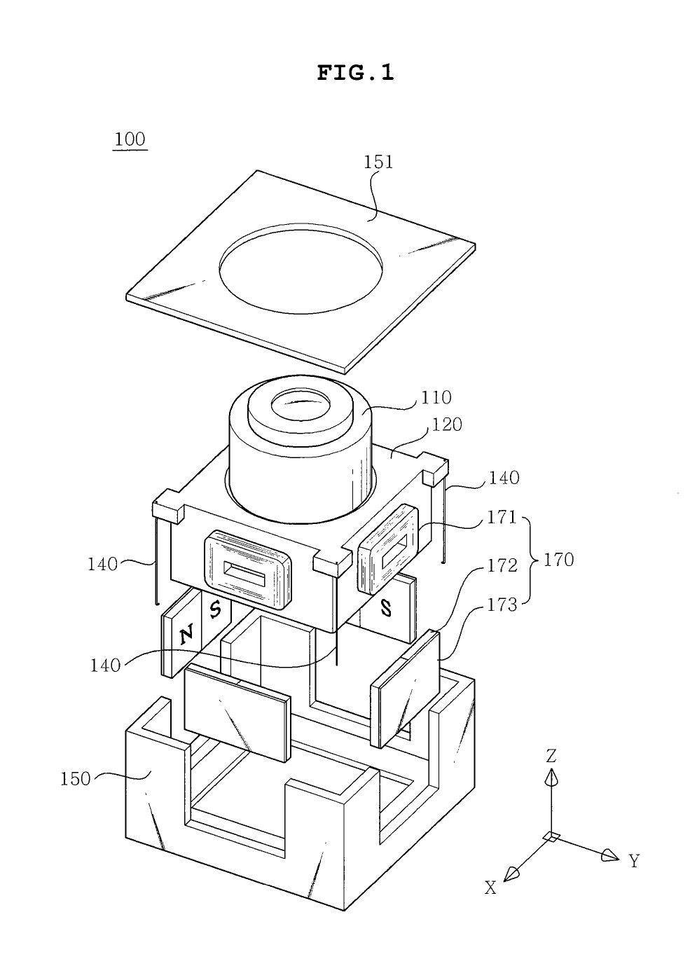

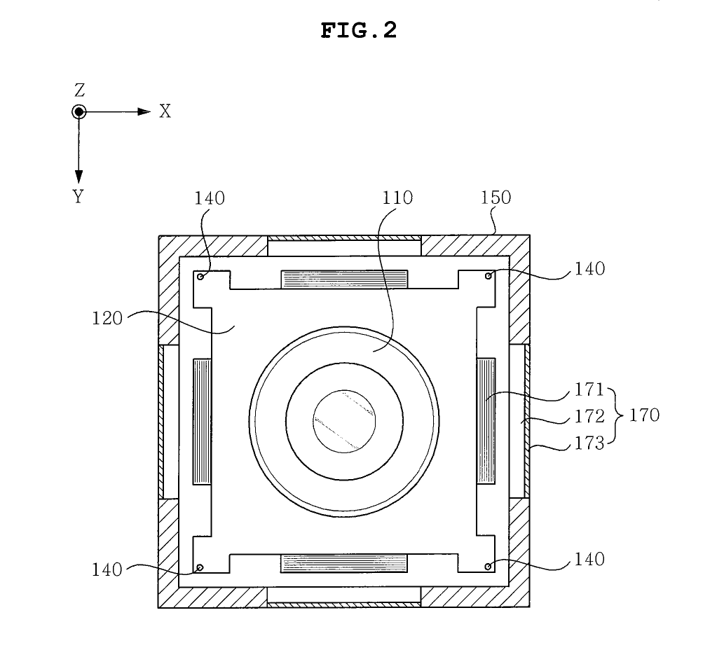

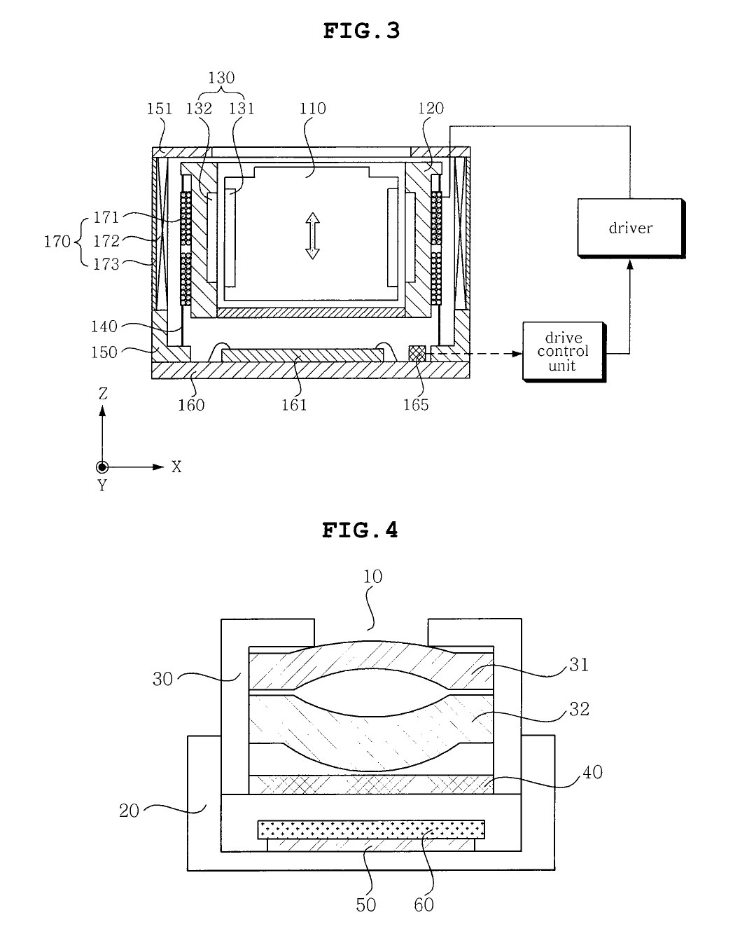

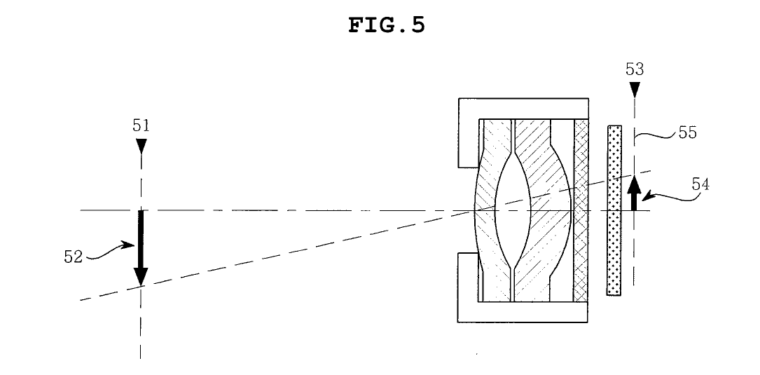

As shown in FIGS. 1 to 3, the camera module 100 equipped with a vibration compensation mechanism according to an embodiment of the present invention includes a lens unit 110, a housing 120, an auto-focus actuator unit 130, a suspension member 140, a case 150, a circuit board 160, and a compensation actuator 170.

The lens unit 110 includes a plurality of lenses which are used to change an image of a subject at a specific magnification.

The housing 120 accommodates the lens unit 110, allows the lens unit 110 to move in the direction of an optical axis, and includes an auto-focus actuator unit 130 therein.

The auto-focus actuator unit 130 is used to move the lens unit 110 in the direction of an optical axis, is provided in the housing 120, and may be formed of a voice-coil, piezoelectric or shape memory actuator.

A first coil 131 is wound around the outer surface of the lens unit 110, and a first magnet 132 is disposed in the housing 120 to be opposite to the first coil 131. The above-described auto-focus actuator unit 130 moves the lens unit 110 in the Z direction, that is, the direction of an optical axis, using electromagnetic force which is generated between an electric field attributable to current flowing through the first coil 131 and a magnetic field attributable to the first magnet 132.

The suspension members 140 support the housing 120 in parallel with the direction of the optical axis so that the housing 120 can move in the direction perpendicular to the direction of the optical axis direction. Here, the suspension member 140 may be formed of suspension wires or plate springs, and are provided at the four corners of the housing 120. Furthermore, the suspension members 140 support the housing 120, thereby preventing the housing 120 from inclining with respect to the direction of the optical axis.

The case 150 is used to accommodate the housing 120 and the suspension member 140 supporting the housing 120. Furthermore, the case 150 is configured so that a hole through which an image sensor 161 passes is formed in its bottom, the suspension members 140 are fastened to its bottom and a cover plate 151 is mounted on its top.

The circuit board 160 is provided with the image sensor 161, and is disposed on the case 150. Various types of passive elements for driving the auto-focus actuator unit 130 and the compensation actuator 170 together with the image sensor 161 are disposed above the circuit board 160.

The compensation actuator 170 is used to compensate for the horizontal vibration of the housing 120 in the X and Z directions, which results from the vibration of the user's hands. The compensation actuator 170 is mounted on the housing 120 and the case 150, and includes second coils 171, second magnets 172, and metallic yokes 173.

The second coils 171 are wound in rectangle or square form, and are mounted on the four side walls of the housing 120, respectively. Current flows through the second coils 171. The second magnets 172 are mounted on the four side walls of the case 150 to face the four second coils 171, respectively. The magnetic force of the second magnets 172 is concentrated on the second coils 171 by the metallic yokes 173.

The compensation actuator 170 is mounted besides the lens unit 110 and does not influence the thickness of the camera, which is consistent with the trend of recent cameras toward thinness and light weight. Furthermore, the compensation actuator 170 does not influence the weight of the lens unit 110 driven by the auto-focus actuator unit 130 and therefore does not influence the amount of current which is consumed when the lens unit 110 moves vertically.

A vibration compensation method according to the present invention will now be described. When the displacement of the housing 120 is sensed, a signal is sent to a drive control unit by the displacement sensor 165, the signal is sent from the drive control unit to a driver, and the signal is sent to the second coils 171, thereby driving the compensation actuator 170. That is, when the vibration of the hands of a user is sensed by the displacement sensor 165 while an image of a subject is being captured, a signal is sent to the drive control unit and the lens unit 110 is moved in the X and Y directions, thereby focusing the lenses of the camera.

Even when the vibration of the hands is transmitted to the housing 120, the housing 120 is always maintained at a reference location by the compensation of the compensation actuator 170, and therefore an image of a subject captured by the image sensor 161 via the lens unit 110 becomes clear.

The above-described configuration has the advantage of directly providing a vibration compensation function by modifying the outer portion of a conventional auto-focus camera module. Furthermore, a support and guide structure required in the guide or ball structure of a conventional camera module can be omitted, so that it is possible to realize a simple structure, easy assembly and small size. Moreover, the inclination of the auto-focus actuator unit 130 which may occur with respect to the direction of an optical axis can be reduced by using the suspension members 140.

Although the camera module equipped with a vibration compensation mechanism according to the present invention has been described with reference to the preferred embodiment, it will be apparent to those skilled in the art that various modifications, additions and substitutions are possible within the range which does not depart from the spirit of the invention.

1. A camera module equipped with a vibration compensation mechanism, comprising:
a lens unit comprising a plurality of lenses for changing an image of a subject at a specific magnification;
a housing for accommodating the lens unit so that the lens unit can move in a direction of an optical axis;
an auto-focus actuator unit installed in the lens unit and the housing so that the lens unit can move in the direction of the optical axis;
suspension members for supporting the housing in parallel with the direction of the optical axis so that the housing can float in a direction perpendicular to the direction of the optical axis;
a box-type case configured so that the suspension members are fastened thereto and the housing is accommodated therein;
a circuit board disposed beneath the case and configured so that an image sensor is installed thereon; and
a compensation actuator installed in the housing and the case and configured to compensate for a displacement caused by a vibration of the housing.

2. The camera module as set forth in claim 1, wherein the suspension members are four suspension wires which support four corners of the box-type housing.

3. The camera module as set forth in claim 1, further comprising a displacement sensor for sensing a vibration displacement of the housing.

4. The camera module as set forth in claim 1, wherein the auto-focus actuator unit is formed of a voice-coil, piezoelectric, or Shape Memory Alloy (SMA) actuator.

5. The camera module as set forth in claim 1, wherein the compensation actuator comprises second coils provided on four side walls of the housing, respectively, second magnets provided on four side walls of the case to face the second coils, respectively, and metallic yokes configured to concentrate magnetic force of the magnets.
